(19) United States
(12) Patent Application Publication
(10) Pub. No.: US 2017/0215637 A1
(43) Pub. Date: Aug. 3, 2017

(54) Tamale Cooking Aid

(71) Applicant: Shelly Gay Sanborn, Spokane, WA (US)

(72) Inventor: Shelly Gay Sanborn, Spokane, WA (US)

(21) Appl. No.: 15/008,840

(22) Filed: Jan. 28, 2016

(51) Int. Cl. A47J 36/20; A23P 30/10; A23L 5/10; A47J 43/20; A47J 27/04

(52) U.S. Cl. CPC A47J 36/20; A47J 43/20; A47J 27/04; A23L 5/13; A23P 30/10; A47J 2027/043; A23V 2002/00

(57) ABSTRACT

An apparatus for cooking tamales includes a lid, a base, and a hinge. The lid comprises a semi-rigid, food safe material. It may have an elongated shape and a plurality of perforations to allow steam to pass through the lid. The base comprises a semi-rigid, food safe material. It may also have an elongated shape and a plurality of perforations to allow steam to pass through the base. The hinge connects the lid and the base such that the lid and the base define a cavity when closed against each other. The cavity defined by the lid and the base is shaped to hold a tamale for cooking.

### BACKGROUND

Steaming is a common way of cooking many food items. Typical steaming methods usually involve placing a food item into a pot and then boiling an amount of water within the pot to allow the resulting steam to cook the food contained within the pot. In some scenarios, a basket for elevating the food above the water in the pot may be used to prevent the food from becoming soggy or wet as the water boils. Tamales are often made through a steaming process.

### SUMMARY

An apparatus for cooking tamales includes a lid, a base, and a hinge. The lid comprises a semi-rigid, food safe material. It may have an elongated shape and a plurality of perforations to allow steam to pass through the lid. The base comprises a semi-rigid, food safe material. It may also have an elongated shape and a plurality of perforations to allow steam to pass through the base. The hinge connects the lid and the base such that the lid and the base define a cavity when closed against each other. The cavity defined by the lid and the base is shaped to hold a tamale for cooking.

In other instances, an apparatus for making tamales may include a first half member comprising a flexible, shape retaining material. The apparatus may also comprise a second half member comprising a flexible, shape retaining material. The first half member and the second half member are connected by a hinge and are configured to close in a clam shell-like manner to form a tamale mold. The tamale mold is sufficiently rigid to hold a tamale closed, the tamale mold defines a plurality of steam holes along the length of the tamale mold.

One way of cooking tamales involves using a tamale maker having a plurality of perforations that opens in a clamshell-style manner. An example method includes opening the tamale maker, placing a corn husk with dough and filling into the tamale maker, closing the tamale maker causing the corn husk to mold to the tamale maker, placing the tamale maker into a steamer, and allowing steam to rise through the plurality of perforations, thereby cooking the tamale. In other instances, the corn husk need not be used and dough and filling may be directly placed into the tamale maker.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. Furthermore, the claimed subject matter is not limited to implementations that solve any or all disadvantages noted in any part of this disclosure. These and various other features may be apparent from a reading of the following Detailed Description and a review of the associated drawings.

### DESCRIPTION OF THE DRAWINGS

FIG. 1 depicts a top view of an exemplary tamale maker in an open position;

FIG. 2 depicts a top view of the tamale maker in FIG. 1 in a closed position;

FIG. 3 depicts a top view of the tamale maker in FIG. 1 placed in a steamer; and

FIG. 4 shows a method of using a tamale maker.

### DETAILED DESCRIPTION

Cooking tamales often involves steaming the tamales for a duration of time until the tamale is cooked through. In some instances, tamales can be stacked vertically when placed into a steamer so as to fit as many tamales as possible into a steaming pot. However, vertical stacking can often lead to uneven steaming, which may lead to an unevenly cooked tamale. As a result, it is preferable to steam tamales in a horizontal orientation. Tamales are often made by wrapping dough and filling with corn husks. The ends of the corn husks are tied up to prevent filling from falling out. Due to the typical cooking times required for tamales (sometimes upwards 24 hours), it is desirable to retain the filling within the tamale. By tying up the ends, multiple tamales may be placed into a steaming pot without risk of the tamales breaking or inadvertently opening.

Wrapping the filling of a tamale with corn husk and tying the ends of the husk can be time consuming. Furthermore, it may require more dexterity and time than a user has available to tie the ends of the corn husk while making the tamale. All of these challenges could be frustrating for a user that is attempting to make tamales.

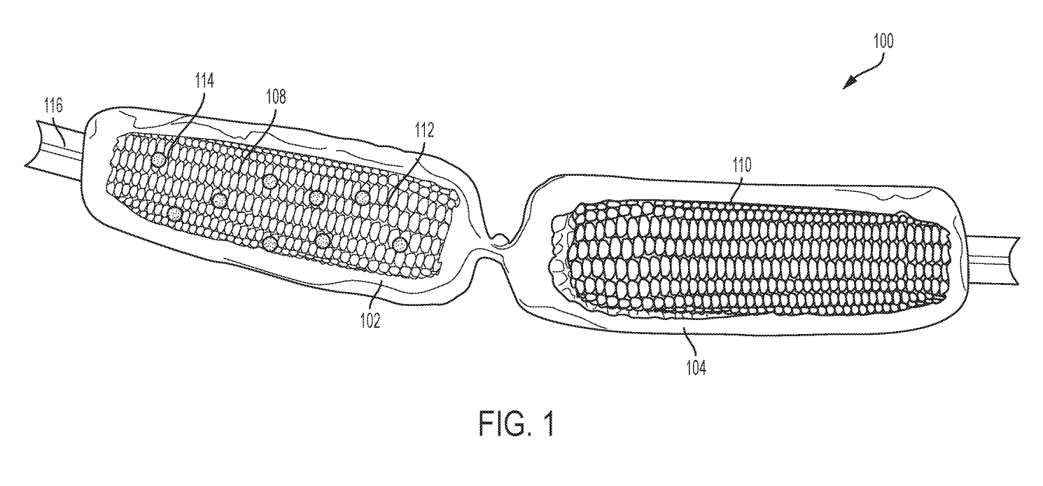

FIG. 1 shows an exemplary tamale maker 100. Tamale maker 100 comprises a lid 102 and a base 104 that close in a clamshell like manner. As seen in FIG. 1, tamale maker 100 is shaped to hold a tamale 110 between lid 102 and base 104. Lid 102 has a length just longer than the desired length of tamale 110 such that when lid 102 closes over base 104 to hold tamale 110, tamale 110 is completely covered, thereby preventing food material contained in tamale 110 from falling out.

Likewise, base 104 is dimensioned to extended just farther than the length of tamale 110 such that tamale 110 is fully covered when lid 102 and based 104 close upon tamale 110. While in the exemplary version, lid 102 and base 104 are similar in shape, it will be understood that lid 102 and base 104 need not be the same length.

Tamale maker 100 can be constructed of a food safe material such that tamale makers 100 can be placed into a steamer basket or any other suitable cooking receptacle to cook tamale 110. In many instances, a user will place multiple tamale makers 100 into a steamer basket stacked upon each other. Tamale maker 100 can be constructed of a semi-flexible material such that when placed into a steamer basket, tamale maker 100 can bend and flex slightly to accommodate as many possible tamale makers 100 in a steamer basket.

Tamale maker 100 can be constructed of a semi-rigid material such as a food grade silicon. In other instances, tamale maker 100 may be constructed of stainless steel, aluminum, polyurethane or any polymer-like material, elastomers or any vulcanized rubber-like material. It will be understood that tamale maker 100 may also be forms of a non-stick material such that once tamales 110 are cooked in tamale maker 100, tamales 110 do not stick to tamale maker 100 during removal. The semi-rigid material of tamale maker 100 is generally able to retain its form. Furthermore, when tamale 110 is cooked, tamale maker 100 can mold tamale 110 into a desired shape based on the shape of tamale maker 100. As seen in FIG. 1, the inner walls 108 of lid 102 and base 104 have a concave shape to accommodate tamale 110 when placed in tamale maker 100. When lid 102 closes upon base 104, inner walls 108 help mold tamale 110 such that during the cooking process, tamale 110 acquires the shape of inner walls 108. In the depicted embodiment, inner walls 108 also have a corn shaped pattern 112. As a result, when tamale 110 cooks inside tamale maker 100, tamale 110 is molded to look like an ear of corn. While the present embodiment uses a corn pattern 112 to mold tamale 110, any suitable vegetable or other food shape can be used to imprint tamale 110 as it cooks. For instance, tamale maker 100 could be shaped to mold the tamale contained therein into jalapeño peppers, carrots, avocados, tomatoes, bananas, pears, or pineapples.

In some instances, tamale maker 100 may have a dessert shaped pattern such that the food cooked therein is formed to look like a dessert item. For instance, inner walls 108 of tamale maker 100 can be shaped to have the imprint of a slice of cake, a cupcake, piece of fruit, or any other suitable shape that might be helpful to imply that the food formed is a dessert food item. Additionally, the dough used in tamale maker 100 may also have additional sugar, chocolate, or other dessert ingredients.

Tamale maker 100 may also have a plurality of perforations 114 formed therein. Perforations 114 should be large enough to allow steam or hot vapor to pass through tamale maker 100. Once one or more tamale makers 100 are placed into a pot or steamer, steam is used to cook tamales 110. Perforations 114 allow steam to pass through tamale makers 100 such that even when tamale makers 100 are stacked upon each other, all of them are exposed to a sufficient amount of steam to allow tamales 110 to cook. Additionally, perforations 114 should span the length of tamale maker 100. It will be understood that in some versions, only a portion of tamale maker 100 will have perforations 114. Additionally, while perforations 114 have a circular shape in the illustrated version, it will be understood that any suitable shape may be used for perforations 114. For instance, elongated vents or slits could be used in place of perforations 114. Mesh regions could also be used in place of perforations 114.

During the cooking of tamale 110, it is desirable to have lid 102 and base 104 close securely such that lid 102 does not separate from base 104. As a result, tamale 110 can be cooked without breaking open during the steaming process. Tabs 116 can be used to keep lid 102 and base 104 together while tamale 110 is cooking. Tabs 116 in the exemplary version comprises a shaped fastener to clip lid 102 to base 104. However, it will be understood that tabs 116 can have any suitable shape for keeping lid 102 closed on base 104. For instance, rather than tabs 116, a fastener, clip, clamp, or any other suitable component may be used to hold lid 102 against base 104.

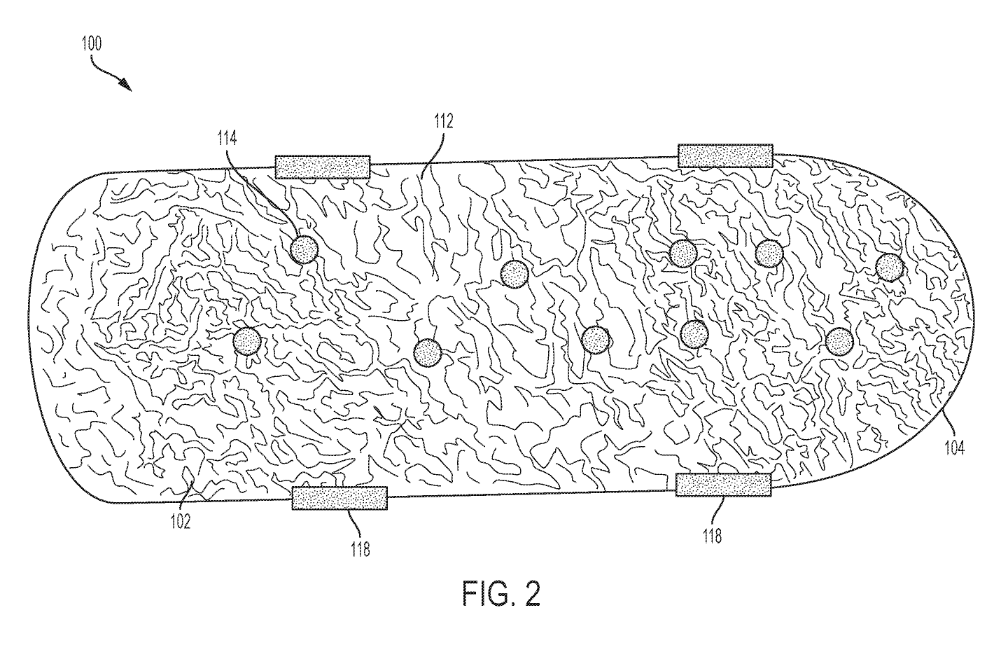

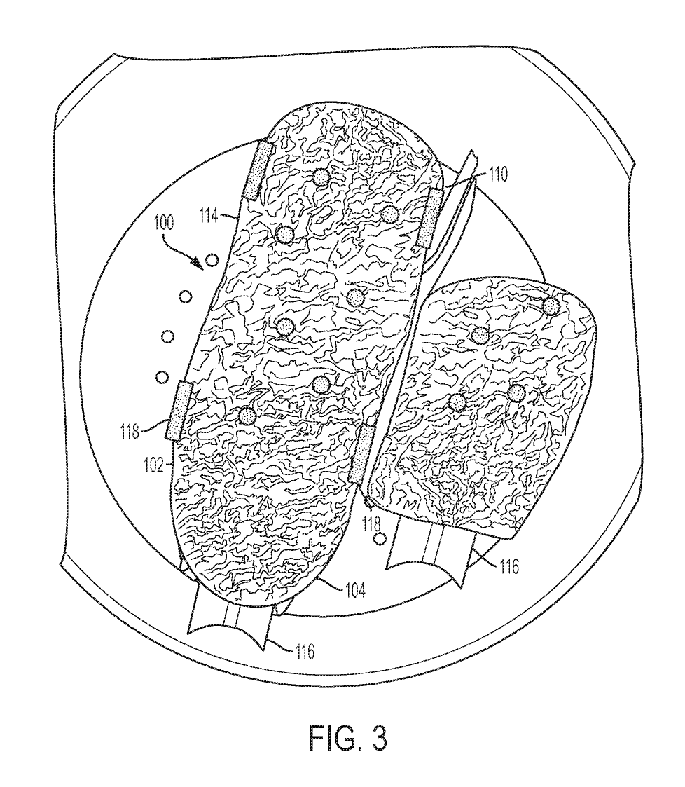

It will be appreciated that tamale maker 100 is constructed of a semi rigid material such that multiple tamale makers 100 may be stacked. FIG. 2 shows a plurality of alignment clips 118 on tamale maker 100. Tamale maker 100 may be molded to incorporate alignment clips 118 so that alignment clips 118 are built into tamale maker 100. In other versions, alignment clips 118 may be attached to tamale maker 100 after tamale maker 100 is constructed. Using alignment clips 118, the user may place tamale makers 100 into a steamer or other cooking pot. Alignment clips 118 can be used to ensure that tamale makers 100 can be stacked in a uniform manner without falling over. As a result, the user may be able to more easily position tamale makers 100 in a pot. It will be understood though that alignment clips 118 are not necessary, and the user may indeed cook many tamales 110 in many tamale makers 100 by simply placing tamale makers 100 into a pot or other cooking device regardless of how the tamale makers 100 fall. FIG. 3 shows tamale makers 100 placed into a steamer for cooking. It will be understood that as tamale maker 100 is steamed, the tamale 110 contained inside will cook by steam and heat passing through perforations 114.

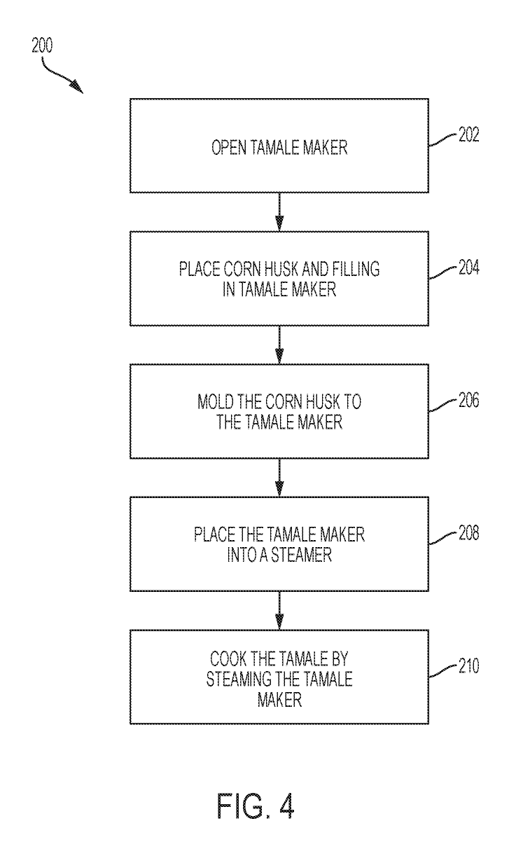

In one use scenario, a user can easily make tamales 110 using tamale maker 100 as shown by the method in FIG. 4. Lid 102 can be separated from base 104 to open tamale maker 100 as shown in block 202. The user may then place dough, filling, or other ingredients into base 104 of tamale maker 100 as shown in block 204. In some instances, the user could also place corn husk into tamale maker 100, though it will be understood that including corn husk is not necessary. For instance, dough and filling may be placed directly into tamale maker. Then, the user may close lid 102 upon base 104 to prepare tamale 110 for steaming such that the tamale acquires the molded shape of tamale maker 100 as shown in block 206. The user may fill many tamale makers 100, thereby preparing many tamales 110 for steaming. If desired, the user may engage tabs 116 to keep lid 102 closed upon base 104. As a result, the user may place multiple tamale makers 100 into a steamer or other cooking container to steam tamales 110 as shown in block 208. In some instances, the user will want to stack tamale makers 100 in order to better arrange tamales 110 in a steamer. The user may place tamale makers 100 uniformly on top of each other by positioning tamale makers 100 such that alignment tabs 118 of stacked tamale makers 100 are coupled.

The tamales 110 can then be steamed for any suitable length of time as shown in block 210. For instance, the user can steam tamales 110 in tamale makers 100 for up to 24 hours or more. As the steamer heats and cooks tamales 110, steam rises through the steamer and travels through perforations 114 to cook tamale 110 contained therein. After tamales 110 are fully cooked, the user can remove tamale makers 100 from steamer to complete the cooking process. It will be understood that other methods and ways of using tamale maker 100 will be contemplated by one of ordinary skill in the art in view of the teachings herein.

The subject matter described above is provided by way of illustration only and may not be construed as limiting. Various modifications and changes may be made to the subject matter described herein without following the example embodiments and applications illustrated and described, and without departing from the true spirit and scope of the present invention, which is set forth in the following claims.

What is claimed:

1. An apparatus for cooking tamales, the apparatus comprising:
a lid comprising a semi-rigid, food safe material, the lid having an elongated shape, the lid defining a first plurality of perforations formed therein such that the first plurality of perforations allow steam to pass therethrough;
a base comprising a semi-rigid, food safe material, the base having an elongated shape matched to the lid, the base defining a second plurality of perforations formed therein such that the second plurality of perforations allow steam to pass therethrough; and
a hinge connecting the lid and the base such that the lid and the base define a cavity when closed against each other, wherein the cavity defined by the lid and the base is shaped to hold a tamale.

2. The apparatus of claim 1, wherein the first plurality of perforations extends along the length of the lid and the second plurality of perforations extends along the length of the base.

3. The apparatus of claim 1, wherein the lid and the base comprise a food grade silicon.

4. The apparatus of claim 1, wherein the lid defines a concave inner wall shaped like corn kernels.

5. The apparatus of claim 1, wherein the base defines a concave inner wall shaped like corn kernels.

6. The apparatus of claim 1, wherein the lid and the base both define a concave cavity configured to imprint an ear of corn pattern on a food item contained therein.

7. The apparatus of claim 1, further comprising one or more tabs connected to the lid or the base, the one or more tabs able to hold the lid closed against the base.

8. The apparatus of claim 1, further comprising at least one alignment clip configured to align the base with another cooking device.

9. An apparatus comprising:
a first half member comprising a flexible, shape retaining material;
a second half member comprising a flexible, shape retaining material, wherein the first half member and the second half member are connected by a hinge and are configured to close in a clam shell-like manner to form a tamale mold, the tamale mold being sufficiently rigid to hold a tamale closed, the tamale mold defining a plurality of steam holes along the length of the tamale mold.

10. The apparatus of claim 9, wherein the first half member and the second half member comprise a food grade silicon.

11. The apparatus of claim 9, wherein an inner portion of the first half member is molded to have an imprint of an ear of corn.

12. The apparatus of claim 9, further comprising one or more fastening members in selective communication with the first half member and the second half member operable to hold the first half member and the second half member together.

13. The apparatus of claim 12, wherein the one or more fastening members comprises a resilient tab.

14. The apparatus of claim 9, wherein the first half member and the second half member have an elongated shape.

15. The apparatus of claim 9, further comprising at least one alignment member in communication with the first half member configured to clip the first half member onto another cooking device.

16. The apparatus of claim 14, further comprising at least one alignment member in communication with the second half member configured to clip the second half member onto another cooking device.

17. A method for cooking tamales using a tamale maker having a plurality of perforations extending therethrough, the tamale maker configured to open in a clamshell-style manner, the tamale maker comprising a semi-rigid material able to mold an article of food, the method comprising:
opening the tamale maker;
placing a dough with filling into the tamale maker;
closing the tamale maker causing the dough to mold to the tamale maker;
placing the tamale maker into a steamer; and
allowing steam to rise through the plurality of perforations, thereby cooking the tamale.

18. The method of claim 17, further comprising imprinting a corn kernel pattern into the tamale with the tamale maker.

19. The method of claim 17, further comprising clipping the tamale maker shut prior to placing the tamale maker into a steamer.

20. The method of claim 17, further comprising stacking more than one tamale makers into a steaming container.
